(19) United States
(12) Patent Application Publication
(10) Pub. No.: US 2002/0031046 A1
(43) Pub. Date: Mar. 14, 2002

(54) Method for mixing fluids or fluids with solid particles

(76) Inventors: Gottlieb Schneider, Seuzach (CH); Shaffiq Jaffer, Loveland, OH (US)

Correspondence Address: James H. Marsh, Jr., SHOOK, HARDY & BACON L.L.P., 1200 Main Street, Kansas City, MO, 64105-2118, US

(21) Appl. No.: 09/946,656

(22) Filed: Sep. 5, 2001

Related U.S. Application Data
(62) Division of application No. 09/552,234, filed on Apr. 19, 2000.
(60) Provisional application No. 60/129,946, filed on Apr. 19, 1999.

(51) Int. Cl. B01F 5/06

(52) U.S. Cl. 366/181.5; 366/337

(57) ABSTRACT

A method for mixing one or more fluid streams or for mixing solid particles with one or more fluid streams involves flowing the materials to be mixed through a static fluid mixer. The mixer includes an elongated fluid flow conduit having a centrally located longitudinally extending axis and an inner generally cylindrical wall extending around said axis and defining a fluid flow path within the conduit which extends along the central axis of the conduit. The mixer also includes at least two circumferentially offset internal baffle members designed to create countery-rotating vortices in fluids passing through the conduit. The first baffle is in the form of an elongated inclined plate positioned in said fluid flow path at a first location in said conduit. This baffle plate has an upstream end, a downstream end and a longitudinal axis. The first baffle plate is mounted on a mounting which extends between the wall and the downstream face of the baffle plate so that the upstream end of the first baffle plate is spaced radially from the wall a first distance which is less than a radius of the conduit. The downstream end of the first baffle plate is spaced radially from the wall a second distance which is greater than said first distance so that the baffle plate is disposed at an angle relative to the longitudinal axis of the conduit. The second baffle member has a configuration and arrangement which is essentially the same as the first baffle, except that the second baffle member is circumferentially offset approximately 90 degrees and spaced longitudinally of the conduit from the first baffle member. The upstream ends of the baffle members are spaced from the wall so as to permit fluid flow around the upstream ends to thereby minimize eddy currents and the like behind the baffle members. This arrangement facilitates complete mixing of fluids with other fluids and/or with solid particles flowing through the conduit.

### CROSS REFERENCE TO RELATED APPLICATION

This application is a divisional of co-pending application Ser. No. 09/552,234 filed on Apr. 19, 2000, the entirety of which is hereby specifically incorporated herein by reference. Priority under 35 U.S.C. § 119(e) from provisional application Ser. No. 60/129,946 filed on Apr. 19, 1999 was claimed in said application Ser. No. 09/552,234, and such claim is repeated herein. The entireties of the respective disclosures of said applications Ser. Nos. 09/552,234 and 60/129,946 are hereby specifically incorporated herein by reference.

### BACKGROUND OF THE INVENTION

1. Field of the Invention

The present application relates generally to methods for mixing one or more fluids and/or for mixing fluids with solid particles using static fluid mixers and particularly to such mixing static mixers which generate fluid mixing vortices.

2. The State of the Prior Art

Static mixers positioned within pipes or other conduits are used in a variety of applications to facilitate mixing of one or more fluid streams flowing within the conduits. For example, static mixers are used to cause a homogenous distribution of a gas or solid particles within a liquid stream, for mixing of two or more gas or liquid streams, and for mixing a single fluid stream to cause a more uniform distribution of temperature, velocity or other fluid properties.

Certain types of static mixers, known as vortex mixers, are specifically designed to cause mixing by creating swirling vortices of fluid. Examples of such vortex mixers are shown in U.S. Pat. No. 4,307,697 to Ong, U.S. Pat. No. 5,330,267 to Tauscher, U.S. Pat. No. 5,456,533 to Streiffet al., U.S. Pat. Nos. 4,929,088 and 4,981,368 to Smith, U.S. Pat. No. 5,489,153, and U.S. Pat. No. 5,813,762, each of which is incorporated herein by reference.

It is generally desirable for a vortex mixer to provide both a short mixing flow path and a small pressure loss under a variety of different flow conditions and fluid compositions. In addition to achieving high efficiency, it is also desirable for the vortex mixer to be of simple, yet durable, construction for ease of fabrication and reduced cost. The above-referenced vortex mixers meet these objectives to varying degrees; however, the need for an improved vortex mixer continues.

### SUMMARY OF THE INVENTION

It is an object of this invention to provide a method for static mixing that facilitates the provision of high mixing efficiency across a range of different fluid flow rates so that the method is applicable to a variety of different applications.

It is also an object of this invention to provide a method for static mixing which facilitates high mixing efficiency for two or more substances, such as gas and liquid streams or solid particles and fluid streams, flowing within a conduit across a wide range of ratios of one substance to the other(s) so that the method is useful in many different applications.

It is another object of this invention to provide a static mixer that achieves a high degree of mixing while causing only a relatively low pressure drop so that energy losses can be maintained within preselected limits.

It is yet another object of this invention to provide a method for static mixing that avoids the collection of fibers or other solid particles on surfaces of the mixer apparatus so that the opportunity for clogging of the conduit is minimized when fluids containing fibers or solid particles are flowing through the conduit.

It is a further object of this invention to provide a method for static mixing that facilitates the use of a mixer having a simple configuration and which is made from a minimum amount of material so that low fabrication and manufacturing costs can be obtained.

As a corollary to the preceding object, it is a still further object to provide a method for static mixing that permits the use of a mixer having a strong and stable construction so that it able to resist vibrations and fluid forces with minimal risk of failure.

In its broadest application, the invention provides a method of mixing one or more fluid streams comprising providing a static fluid mixer as described hereinafter and causing one or more fluid streams to flow along the fluid flow path defined by the conduit. The invention also provides a method of mixing solid particles with one or more fluid streams comprising providing a static fluid mixer as described hereinafter and causing a stream of solid particles and one or more fluid streams to flow along the fluid flow path defined by the conduit.

To achieve these and other related objects of the invention, the method for static mixing employs, in the preferred embodiment, a mixer having only two baffle members positioned within a preselected length of conduit, one baffle member being positioned downstream from and at approximately a 90 degree offset from the other baffle member. Each baffle member is constructed in a manner to create a pair of counter-rotating vortices that are able to spread across the entire cross section of the conduit. Because of the offset baffle members, the static mixer produces mixing distribution in two main directions across the cross section of fluid flow, further contributing to homogenous mixing along a relatively short length of conduit and with a minimum of pressure drop.

Specifically in one broad aspect, the invention provides a method for static fluid mixing that comprises providing an elongated fluid flow conduit having a centrally located longitudinally extending axis and an inner generally cylindrical wall extending around said axis and defining a fluid flow path within the conduit which extends along said central axis. Also the method includes the provision of a first elongated inclined baffle member positioned in said fluid flow path at a first location in said conduit and a second elongated inclined baffle member positioned in said fluid flow path at a second location in said conduit. The second location is offset circumferentially from the first location and the same is spaced longitudinally of the conduit from said first location. The arrangement of the baffle members is such that the mixer includes no additional baffle members which are aligned either circumferentially or longitudinally with either the first baffle member or the second baffle member. Finally, the method comprises causing one or more fluid streams to flow along the fluid flow path defined by the conduit and/or causing a stream of solid particles and one or more fluid streams to flow along the fluid flow path defined by the conduit.

In another broad aspect, the invention provides a method for static fluid mixing comprising causing one or more fluid streams and/or causing a stream of solid particles and one or more fluid streams to flow along a fluid flow path defined by a conduit providing an elongated fluid flow conduit having a centrally located longitudinally extending axis and an inner generally cylindrical wall extending around said axis. The method further includes the provision in said conduit of a first elongated inclined baffle member positioned in said fluid flow path at a first location in said conduit. The first baffle member is in the form of a plate having an upstream end, a downstream end and a longitudinal axis. The upstream end of the first baffle member is spaced radially from the wall a first distance which is less than a radius of the conduit, and the downstream end of the first baffle member is spaced radially from the conduit a second distance which is greater than said first distance.

The mixer further includes a second elongated inclined baffle member positioned in said fluid flow path at a second location in said conduit. The second baffle member also is preferably in the form of a plate having an upstream end, a downstream end and a longitudinal axis. The upstream end of the second baffle member is spaced radially from the wall a third distance which is less than the radius of the conduit, and the downstream end of the first baffle member is spaced radially from the wall a fourth distance which is greater than said third distance. Preferably the second and fourth distances are such that the baffle members span approximately 70 percent of the diameter of the conduit. It is also preferred that the first and third distances comprise approximately 4 percent of the diameter of the conduit. The second location in the conduit is preferably offset circumferentially from the first location and spaced longitudinally of the conduit a fifth distance from said first location.

The mixer may also include a mounting element for each of said baffle members. Preferably these mounting elements may extend radially of the conduit between a downstream face of a respective baffle and said wall. Ideally, the mounting elements may each be in the form of a member having an edge which contacts the wall of the conduit along a line which is essentially parallel with the central axis. Alternatively at least one of the mounting elements may be in the form of a sparger pipe.

In a preferred form of the invention, the baffle members are of essentially the same shape, the first and third distances are essentially the same, and the second and fourth distances are essentially the same. Ideally, the members may be plates which are trapezoidal in shape. Ideally, the first and third distances are sufficiently large to permit portions of the fluid flowing through the conduit to pass between the upstream ends of the baffle members and the wall.

In yet another preferred aspect of the invention, the downstream ends of the baffle plate members may have laterally spaced corners which are arranged to create counter-rotating vortices in the fluid flowing through the conduit. This arrangement facilitates thorough mixing of the materials flowing through the conduit.

In another preferred form of the invention, the longitudinal distance between the first and second locations where the baffle members are positioned should be in the range of from approximately 2 times to approximately 10 times greater than the radius of the conduit. Ideally, such longitudinal distance may be approximately 4 times larger than said radius.

Preferably, the baffle members may be offset circumferentially approximately 90° apart. In addition, in accordance with another preferred aspect of the invention, a longitudinal axis of each of the baffle members may be inclined at an angle in the range of from about 20 to about 60 degrees relative to the central axis of the conduit. Even more preferably, the longitudinal axes of the baffle members may be inclined at an angle in the range of from about 30 to about 50 degrees relative to the central axis of the conduit. Ideally, the longitudinal axes of the baffle members may each be inclined at an angle of about 35 degrees relative to the central axis of the conduit. In accordance with another preferred aspect of the invention, the upstream ends of the baffle members may be inclined at an angle of about 90 degrees relative to said axis.

The baffle members may ideally be plates which are trapezoidal in shape with downstream ends which are smaller than the upstream ends. In accordance with the principles and concepts of the invention, the baffle plates may have any one of a variety of shapes and configurations. That is to say, the members may be plates which are essentially planar in transverse cross-sectional configuration. Alternatively, the members may be essentially non-planar in transverse cross-sectional configuration, essentially concave in transverse cross-sectional configuration, essentially convex in transverse cross-sectional configuration, or essentially V-shaped in transverse cross-sectional configuration. The baffle members may also include a hollow internal or external passageway providing a flow path for introducing an additive into a flow of fluids passing through the conduit. Alternatively, the baffle members may be in the form of porous and/or foraminous plates.

### BRIEF DESCRIPTION OF THE DRAWINGS

FIG. 1 is an isometric view, partly in cross-section, illustrating the internal components of a static mixer which embodies the principles and concepts of the invention;

FIG. 2 is a front elevational view of the static mixer of FIG. 1;

FIG. 3 is a cross-sectional view taken along line 3-3 of FIG. 2;

FIG. 4 is a front elevational view of another static mixer which embodies the principles and concepts of the invention, but with a different baffle configuration than the mixer of FIGS. 1, 2 and 3;

FIG. 5 is a cross-sectional view taken along line 5-5 of FIG. 4;

FIG. 6 is an elevational cross-sectional view showing a foraminous baffle member;

FIG. 7 through 14 are views showing a variety of useful configurations for baffle members which include sparger pipes and the like; and

FIGS. 15 through 18 are elevational views showing static mixers of the invention with a variety of alternatively shaped baffle members.

### DETAILED DESCRIPTION OF THE PREFERRED EMBODIMENTS

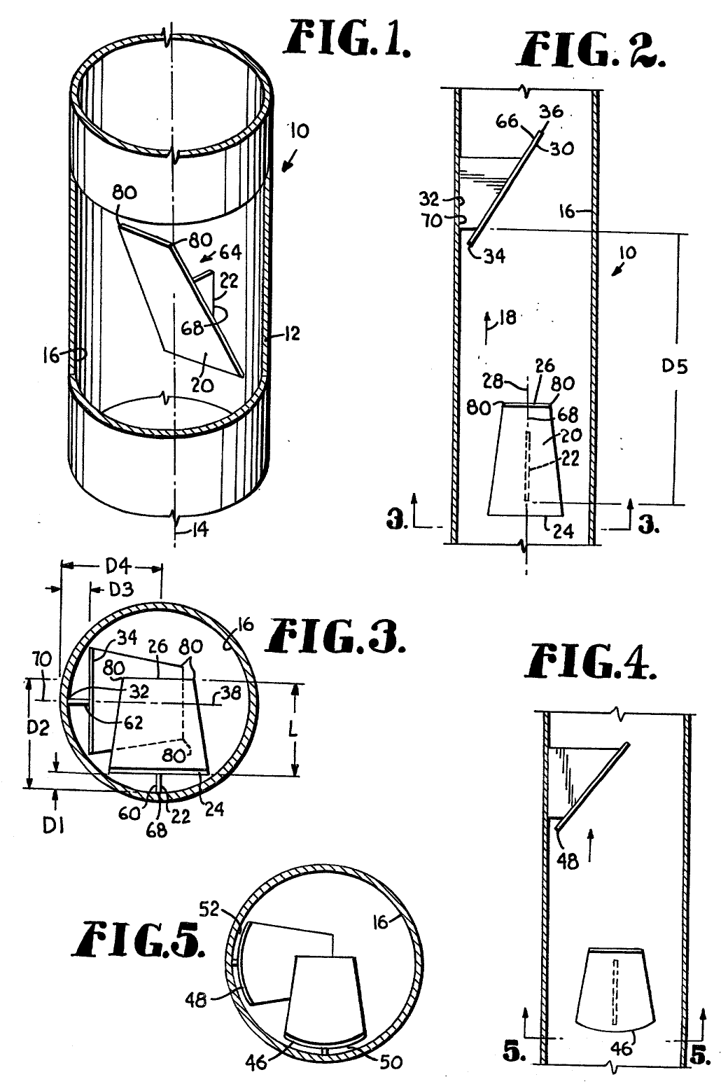

Referring now to the drawings in greater detail, and initially to FIGS. 1-3, a static fluid mixer which embodies the concepts and principles of the invention is identified by the reference numeral 10. Mixer 10 includes an elongated fluid flow conduit 12 having a centrally located longitudinally extending axis 14 and an inner generally cylindrical wall 16 extending around axis 14. Conduit 12 defines a fluid flow path 18 therewithin. An elongated inclined baffle member in the form of plate 20 is positioned in flow path 18 at a location 22 on wall 16. Plate 20 has an upstream end 24, a downstream end 26 and a longitudinal axis 28. Upstream end 24 is preferably spaced radially a distance D1 from location 22 on wall 16. As can be seen in the drawings, distance D1 is generally less than the radius of conduit 12. For that matter, end 24 may be positioned in contact with wall 16 with adequate results if such configuration is desirable. Since plate 20 projects across flow path 18, it is clear that downstream end 26 will be spaced radially from location 22 a distance D2 which is greater than distance D1.

Another elongated inclined baffle member in the form of a plate 30 is positioned in flowpath 18 at a location 32 on wall 16. Plate 30 has an upstream end 34, a downstream end 36 and a longitudinal axis 38. Upstream end 34 is also preferably spaced radially from location 32 on wall 16 a distance D3 which again is less than the radius of conduit 12. Downstream end 36 is spaced radially from location 32 a distance D4 which is greater than distance D3. As can be seen viewing FIG. 3, plates 20 and 30 may preferably be trapezoidal in shape and the lateral dimensions of downstream ends 26 and 36 may preferably be less than the respective lateral dimensions of upstream ends 24 and 34.

As can be seen in FIG. 2, locations 22 and 32 and therefore baffle plates 20 and 30 are spaced apart longitudinally of conduit 12 a distance D5. With reference to FIG. 3 it can be seen that locations 22 and 32 and therefore baffle plates 20 and 30 are also offset circumferentially about the axis 14, preferably at an angle of about 90°; however, the desired offset angle may be more or less than 90° as may be determined empirically depending upon the nature of the fluid to be mixed. The distance D5 between locations 22 and 32 may preferably be within the range of from about 2 to about 10 times as large as the internal radius of conduit 12. Ideally, the distance D5 should be about 4 times as large as the internal radius of conduit 12.

Ideally, in accordance with the concepts and principles of the invention, baffle plates 20 an 30 may be of the same shape. Moreover, the distances D1 and D3 may preferably be about the same, and the distances D2 and D4 may also be about the same. The distances D1 and D3 should preferably be sufficient to permit portions of the fluid flowing along flow path 18 and thereby through conduit 12 to pass between upstream ends 24 and 34 and wall 16. This may prevent eddy currents and dead spots from developing behind plates 20 and 30.

Plates 20 and 30 may preferably have a longitudinal dimension L that is sufficient to span 50 to 75 percent of the diameter of conduit 12. Ideally this dimension L should be such that the plates span about 70 percent of the diameter of conduit 12. Moreover, plates 20 and 30 may preferably be inclined at an angle within the range of from about 20 to about 60 degrees relative to axis 14. Even more preferably this angle of inclination may be within the range of from about 30 to about 50 degrees. Ideally this angle of inclination may be about 35 degrees. As can be seen from FIGS. 3 and 4, the upstream ends 24 and 34 of plates 20 and 30 may preferably be relatively straight and the same may extend laterally at an angle of approximately 90 degrees relative to axis 14.

With reference particularly to FIGS. 1 through 3, it is also preferred that the downstream ends 26 and 36 of plates 20 and 30 provide laterally spaced corners 80 to create counter rotating vortices in the fluid passing through conduit 12 along path 18. These vortices work together to insure thorough mixing of the materials to be mixed throughout the entire extent of the interior of conduit 12.

Baffle plates 20 and 30 may be connected to wall 16 by respective mounting braces in the form of plates 60 and 62 which extend radially of conduit 12 between wall 16 and the respective downstream faces 64 and 66 of plates 20 and 30. As shown, plates 60 and 62 have respective edges 68 and 70 which contact wall 16 on a line which extends longitudinally of conduit 12 along flow path 18. Braces 60 and 62 preferably comprise flat plates that may be affixed to the conduit wall 16 and faces 64 and 66 of the baffle members 20 and 30 by welding or the like. The braces 60 and 62 are oriented so as to present as small a profile as possible in the direction of fluid flow and preferably lies in a plane parallel to the direction of fluid flow. Instead of directly affixing the braces 60 and 62 to the conduit wall 16, the braces may just as well be attached to a ring structure that is inserted into the conduit 16 and is in turn affixed to the conduit wall by friction or other suitable means. An advantage of such a ring structure is it can be readily removed or replaced and can be used to quickly retrofit an existing conduit.

The conduit 12 in which the baffle members 20 and 30 are positioned may be a pipe, duct, tube, trough or other device for carrying one or more fluid streams. The conduit is typically of circular cross-section, but may instead be oval, square, rectangular or other desired polygonal or other shape. The conduit may include a sparger pipe 85 (FIGS. 7-14) or other device for introducing one or more fluids or substances such as solid particles into the main fluid flow channel in a known manner and location. The sparger pipe 85 may also be used as a mounting element for one or more of the baffle members as shown in FIGS. 7-10.

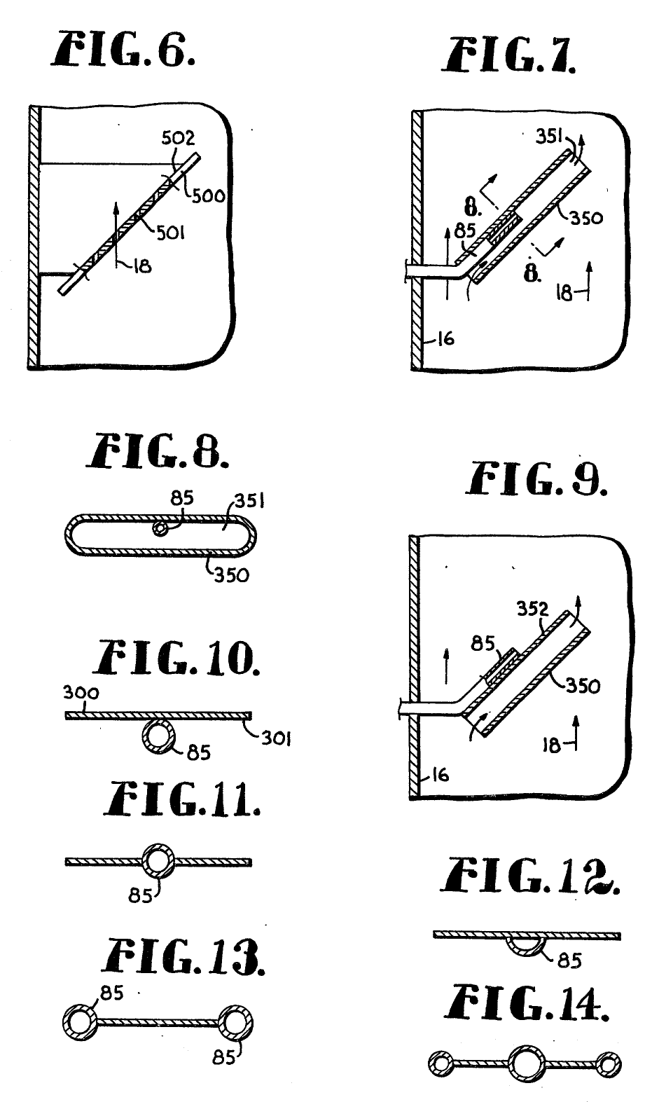

With reference to FIGS. 5 and 6, another embodiment of the invention is shown. In this embodiment, the arrangement is essentially the same as the embodiment of FIGS. 1, 2 and 3, except that the upstream ends 46 and 48 of the baffle plates are arcuate and have a configuration which corresponds generally with the curvature of wall 16. Accordingly, arcuate slots 50 and 52 are presented between wall 16 and the arcuate ends 46 and 48. As before, slots 50 and 52 should be of ample size to permit portions of the fluid flowing through conduit 12 to pass between ends 46 and 48 and wall 16. Preferably, to accomplish this purpose, the width of slots 50 and 52 may ideally be about 4 percent of the internal diameter of conduit 12.

Although other known vortex static mixers are known to employ two or more baffle members at each of multiple locations along the axial length of the conduit, the present invention is directed to the use of only a single baffle member at each of two locations spaced a preselected distance apart in the direction of fluid flow within the conduit, and offset a preselected degree along the conduit wall in the transverse direction. This arrangement of baffle members allows a distribution of inhomogeneity over the entire cross section of conduit in a first main mixing direction as the fluid stream encounters the first baffle member, followed by distribution of the inhomogeneity over the entire cross section of the conduit in a second main direction as the fluid stream encounters the second baffle member. By orienting the baffle members with an approximately 90 degree offset, the first and second main mixing directions are similarly offset so that more complete and uniform mixing can occur with resulting increases in homogeneity. In addition, the use of only a single baffle member at each location facilitates uniform mixing across the entire conduit cross section by allowing the two counter-rotating vortices generated by each baffle member to expand across the entire cross section of the conduit. The use of multiple baffle members at each location might otherwise cause maldistribution of the fluid stream as a result of the production of multiple, interfering vortices.

Sparger pipes used for introducing or dosing additives, such as additional fluid streams or substances, are preferably positioned so that they do not interfere with the counter-rotating vortices formed by the baffle members. Sparger pipes may preferably be located upstream from, or at, the upstream baffle member so that the additives are introduced upstream from the baffle member, at one or more locations along the upstream face of the baffle member, or even along the downstream face of the baffle member. In applications where the additive fluid and the main fluid stream have substantially different densities, it may be particularly desirable to dose the additive fluid at and along the surface of the baffle member so that the fluids are immediately mixed together, thereby reducing the influence of the density difference on the mixing performance. Examples of different dosing structures which may be employed in connection with the present invention are illustrated in FIGS. 7 through 14.

In this latter regard, FIG. 9 illustrates a particularly preferred example of a dosing structure comprising a sparger pipe 85. In FIG. 9, sparger pipe 85 lies on the downstream face 301 of a baffle member 300 which is in the form of a plate. Sparger pipe 85 may be affixed to face 301 by welding or the like. With this arrangement, sparger pipe 85 may provide a mounting element for baffle plate 300. In FIG. 11, the sparger pipe 85 is positioned centrally in the baffle plate. The structure of FIG. 12 is similar to the structure of FIG. 11, except that in this case sparger pipe 85 includes a half round pipe portion that is closed by the baffle plate. The structure of FIG. 13 is again similar to the structure of FIG. 11, except that in this case two sparger pipes 85 are included at the edges of the baffle plate. In FIG. 14, the FIG. 11 structure is combined with the FIG. 13 structure.

With reference to FIGS. 7 and 8, the baffle member 350 is hollow and provides a conduit 351 for fluid to flow therethrough. Sparger pipe 85 is inserted into conduit 351 and may be affixed to baffle member 350 by welding or the like. Again, as can be seen in FIG.7, sparger pipe 85 may serve as a mounting element for attaching baffle member 350 to wall 16. In FIG. 9, the construction is similar to the structure of FIGS. 7 and 8, except that in this case the sparger pipe 85 is attached to the downstream face 352 of baffle member 350.

The baffle member 500 shown in FIG. 6 is similar to the baffle plates 20 and 30 with the exception that in this case the plate is foraminous. That is to say, a plurality of holes 501 are provided in the plate. These holes 501 act to prevent eddy currents and the like from building up at the downstream face 502 of the plate 500.

Preferably, if a sparger pipe is employed, the same should be located at an upstream baffle member. A particular advantage of using a single sparger pipe at the upstream baffle location is that such an arrangement allows the entire additive to be dosed at a single location rather than having to be divided into multiple, equal parts for distribution among a plurality of baffle members as in prior constructions. In addition, because the pressure at the backside of the inclined baffle member is lower than at the front side, the upstream end of the baffle member presents a preferred location for dosing of an additive. The pressure differential causes an increase in the velocity of the main fluid stream, increases the inertial force and Froude-number, and reduces the influence that the density difference between the main fluid stream and the additive has on the degree of homogeneity achieved. As a result, in this area of pressure differential there is an immediate, increased dilution effect on the additive by the main stream.

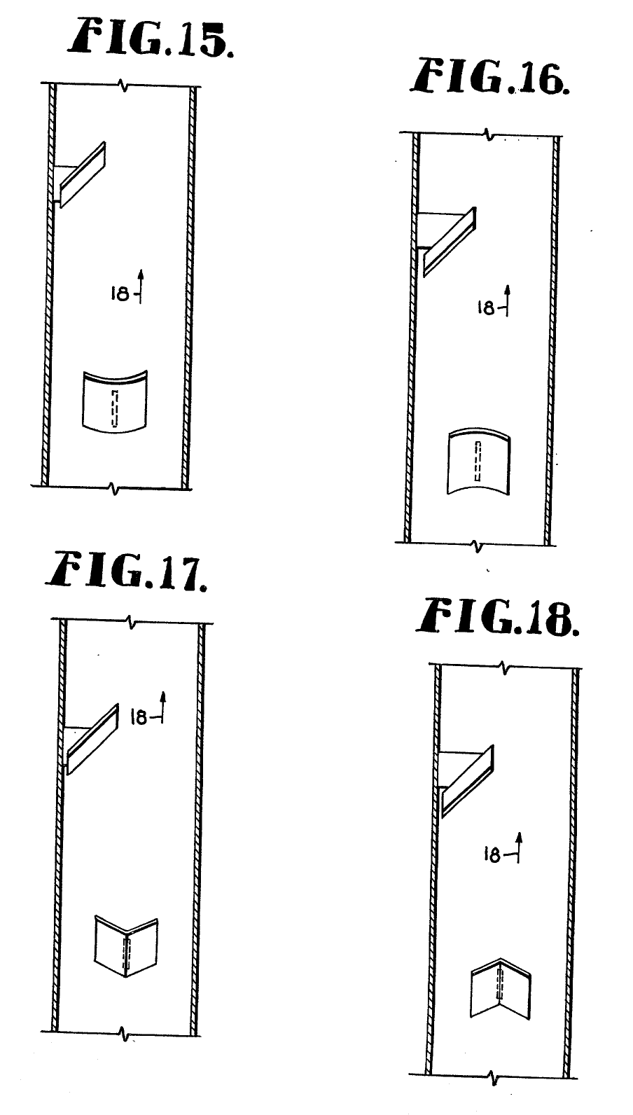

As shown in FIGS. 1 through 5, plates 20 and 30 preferably have a generally planar configuration. However, with reference to FIGS. 15 through 18, a number of different non-planar configurations may be equally useful. Thus, as seen in FIG. 15 the baffle plates may be convex and arcuate, as seen in FIG. 16 the baffle plates may be concave and arcuate, as seen in FIG. 17, the baffle plates may be convex and V-shaped, and as seen in FIG. 18 the baffle plates may be concave and V-shaped.

Because the mixing process is normally completed within a distance of one to three times the conduit diameter downstream from the downstream baffle member, and the distance of separation between the baffle members is on the order of one to five times the conduit diameter, homogeneous mixing can occur within a distance of two to eight times the conduit diameter, and normally three to five times the conduit diameter. In addition to providing effective mixing along a relative short length of conduit, the static mixer of the present invention is particularly notable in that achieves this mixing with a minimum pressure drop and across a wide range of flow rates and ratios of fluids and additives. The relative simple design of the baffle members used in the mixers requires a minimum amount of material and yet is stable and resistant to vibrations that can occur as a result of turbulent fluid flow.

The design of the vortex mixer of the present invention reduces the sensitivity of the mixer to density differences between the main fluid stream and the additive, even at low flow rates and velocities where the Froude-number is extremely small and even small density differences would normally reduce the mixing efficiency or prevent any mixing from occurring. This can be a particular problem in conventional mixer designs when fluids of different densities, such as hot and cold air, hot and cold water, water and an aqueous salt solution or hydrocarbons of different densities, are flowing in straight horizontal flow channels and form stable separate flow layers of fluid.

Although the invention has been described with respect to a two baffle member mixer, in other less preferred embodiments, only a single baffle member or three or more baffle members may be used. When multiple baffle members are used, they are preferably spaced apart in the fluid flow direction, with each baffle member preferably being offset about the periphery of the conduit from each adjacent baffle member. The offset may be 90 degrees, as described with respect to the two baffle member embodiment, or some other selected angle.

The invention is applicable to generally enclosed cylindrical conduits such as pipes and tubes and the like. The invention is also applicable to reclining and/or generally horizontally extending conduits which are not completely enclosed and have an opening, preferably a longitudinally extending opening, at the upper portions thereof. For example, the conduit might by in the form of a horizontally extending ditch or trough or a semicircular piece of pipe having fluids which are moving therealong in a generally horizontal direction. In further accordance with the invention, the mixer may generally simply comprise a relatively short conduit having respective ends which are spaced a short distance beyond said first and second locations so that the mixer may be easily installed and/or removed for maintenance or periodic cleaning.

We claim:

1. A method for mixing a flowable stream which comprises a single fluid, two or more fluids, or one or more fluids and solid particles, said method comprising:
providing an elongated fluid flow conduit having a centrally located longitudinally extending axis and an inner generally cylindrical wall extending around said axis and defining a fluid flow path within the conduit which extends along said central axis;
providing a first elongated inclined baffle member positioned in said fluid flow path adjacent a first location on the wall, said first baffle member having a series of peripheral edges which extends completely therearound, including an upstream end edge and a downstream end edge, said upstream end edge of the first baffle member being spaced radially from the first location a first distance which is less than a radius of the conduit, said downstream end edge of the first baffle member being spaced radially from the first location a second distance which is greater than said first distance;
providing a second elongated inclined baffle member positioned in said fluid flow path adjacent a second location on the wall, said second baffle member having a series of peripheral edges which extends completely therearound, including an upstream end edge and a downstream end edge, said upstream end edge of the second baffle member being spaced radially from the second location a third distance which is less than a radius of the conduit, said downstream end edge of the second elongated baffle member being spaced radially from the second location a fourth distance which is greater than said third distance, said second location being offset circumferentially from said first location and spaced longitudinally of the conduit a fifth distance from said first location; and
causing said flowable stream to flow along said fluid flow path.

2. A method of mixing as set forth in claim 1, wherein said baffle members comprise plates that are of essentially the same shape.

3. A method of mixing as set forth in claim 1, wherein said first and third distances are essentially the same.

4. A method of mixing as set forth in claim 1, wherein said second and fourth distances are essentially the same.

5. A method of mixing as set forth in claim 3, wherein said second and fourth distances are essentially the same.

6. A method of mixing as set forth in claim 2, wherein said first and third distances are essentially the same.

7. A method of mixing as set forth in claim 2, wherein said second and fourth distances are essentially the same.

8. A method of mixing as set forth in claim 6, wherein said second and fourth distances are essentially the same.

9. A method of mixing as set forth in claim 1, wherein said fifth distance is in the range of from about 2 to about 10 times larger than said radius.

10. A method of mixing as set forth in claim 1, wherein said fifth distance is approximately 4 times larger than said radius.

11. A method of mixing as set forth in claim 1, wherein said locations are offset approximately 90° apart about a circumference of the wall.

12. A method of mixing as set forth in claim 1, wherein said first and third distances are sufficiently large to permit portions of the fluid flowing through the conduit to pass between said upstream ends and said wall.

13. A method of mixing as set forth in claim 1, wherein said first baffle member has a longitudinal axis which is inclined at an angle in the range of from about 20 to about 60 degrees relative to said central axis.

14. A method of mixing as set forth in claim 13, wherein said longitudinal axis is inclined at an angle in the range of from about 30 to about 50 degrees relative to said central axis.

15. A method of mixing as set forth in claim 14, wherein said longitudinal axis is inclined at an angle of about 35 degrees relative to said axis.

16. A method of mixing as set forth in claim 1, wherein said baffle members each has a longitudinal axis which is inclined at an angle in the range of from about 20 to about 60 degrees relative to said central axis.

17. A method of mixing as set forth in claim 16, wherein said longitudinal axes are each inclined at an angle in the range of from about 30 to about 50 degrees relative to said central axis.

18. A method of mixing as set forth in claim 17, wherein said longitudinal axes are each inclined at an angle of about 35 degrees relative to said axis.

19. A method of mixing as set forth in claim 1, wherein the upstream ends of said baffle members are inclined at an angle of about 90 degrees relative to said central axis.

20. A method of mixing as set forth in claim 1, wherein the downstream ends of said baffle members have laterally spaced comers which are arranged to create counter-rotating vortices in the fluid flowing through the conduit.

21. A method of mixing as set forth in claim 1, wherein said baffle members are trapezoidal in shape with said downstream ends being smaller than the upstream ends.

22. A method of mixing as set forth in claim 1, wherein said baffles members are plates which are essentially planar in transverse cross-sectional configuration.

23. A method of mixing as set forth in claim 1, wherein said baffles members are essentially non-planar in transverse cross-sectional configuration.

24. A method of mixing as set forth in claim 1, wherein said baffles members are essentially concave in transverse cross-sectional configuration.

25. A method of mixing as set forth in claim 1, wherein said baffles members are essentially convex in transverse cross-sectional configuration.

26. A method of mixing as set forth in claim 1, wherein said baffles members are essentially V-shaped in transverse cross-sectional configuration.

27. A method of mixing as set forth in claim 1, comprising a mounting element for each of said baffle members, each said element extending radially between a downstream face of a respective baffle member and said wall.

28. A method of mixing as set forth in claim 27 wherein each element is generally in the form of a plate having an edge which contacts said wall on a line which extends longitudinally of said conduit.

29. A method of mixing as set forth in claim 1, wherein the upstream ends of the baffle members are arcuate.

30. A method of mixing as set forth in claim 29, wherein the curvature of the arcuate upstream ends of the baffle members essentially corresponds with the curvature of the wall of the conduit, whereby an arcuate slot is presented between said upstream ends and said wall.

31. A method of mixing as set forth in claim 1, wherein at least one of said baffle members includes a hollow passageway therein providing a flow path for introducing an additive into a flow of fluids passing through said conduit.

32. A method of mixing as set forth in claim 27, wherein at least one of said baffles members includes a hollow passageway therein providing a flow path for introducing an additive into a flow of fluids passing through said conduit.

33. A method of mixing as set forth in claim 27, wherein at least one of said mounting elements comprises a sparger pipe.

34. A method of mixing as set forth in claim 32, wherein the mounting element for said at least one baffle member comprises a sparger pipe which communicates with said passageway.

35. A method of mixing as set forth in claim 1, wherein at least one of said baffle members has a longitudinal dimension that is sufficiently long to position the downstream end thereof on the opposite side of the central axis from the upstream side.

36. A method ofmixing as set forth in claim 35, wherein at least one of said baffle members has a longitudinal dimension such that the same spans approximately 70 percent of the diameter of the conduit.

37. A method of mixing as set forth in claim 1, wherein each of said baffle members has a longitudinal dimension that is sufficiently long to position the downstream end thereof on the opposite side of the central axis from the upstream side.

38. A method of mixing as set forth in claim 37, wherein each of said baffle members has a longitudinal dimension such that the same spans approximately 70 percent of the diameter of the conduit.

39. A static mixer as set forth in claim 30, wherein said slot has a width which is approximately 4 percent of the diameter of the conduit.

40. A method of mixing as set forth in claim 1, wherein at least one of said baffle members comprise a sheet having perforations which extend therethrough.

41. A method of mixing a flowable stream which comprises a single fluid, two or more fluids, or one or more fluids and solid particles, said method comprising:
providing an elongated fluid flow conduit having a centrally located longitudinally extending axis and an inner generally cylindrical wall extending around said axis and defining a fluid flow path within the conduit which extends along said central axis;
providing a first elongated inclined baffle member positioned in said fluid flow path at a first location in said conduit;
providing a second elongated inclined baffle member positioned in said fluid flow path at a second location in said conduit, said second location being offset circumferentially from said first location and spaced longitudinally of the conduit from said first location,
the arrangement of said baffle members being such that neither is in contact with said wall and such that said mixer includes no additional baffle members which are aligned either circumferentially or longitudinally with either said first baffle member or said second baffle member; and
causing said flowable stream to flow along said fluid flow path.

42. A method of mixing a flowable stream which comprises a single fluid, two or more fluids, or one or more fluids and solid particles, said method comprising:
providing an elongated fluid flow conduit having a centrally located longitudinally extending axis and an inner wall extending at least part way around said axis and defining a fluid flow path within the conduit which extends along said central axis;
providing a first elongated inclined baffle member positioned in said fluid flow path and adjacent a first location on the wall, said first elongated baffle member having an upstream end, a downstream end and a longitudinal axis, said upstream end of the first baffle member being spaced radially from the first location a short first distance which is less than ½ of a lateral dimension of the conduit but which is sufficiently large to permit a portion of the fluid flowing through the conduit to pass between said upstream ends of the first elongated baffle member and said wall, said downstream end of the first baffle member being spaced radially from the first location a second distance which is greater than said first distance;
providing a second elongated inclined baffle member positioned in said fluid flow path adjacent a second location on the wall, said second elongated baffle member having an upstream end, a downstream end and a longitudinal axis, said upstream end of the second elongated baffle member being spaced radially from the second location a short third distance which is less than ½ of a lateral dimension of the conduit but which is sufficiently large to permit a portion of the fluid flowing through the conduit to pass between said upstream ends of the first elongated baffle member and said wall, said downstream end of the second elongated baffle member being spaced radially from the second location a fourth distance which is greater than said third distance, said second location being offset circumferentially from said first location and spaced longitudinally of the conduit a fifth distance from said first location,
the arrangement of said baffle members being such that neither is in contact with said wall; and
causing said flowable stream to flow along said fluid flow path.

43. A method of mixing a flowable stream which comprises a single fluid, two or more fluids, or one or more fluids and solid particles, said method comprising:
providing an elongated fluid flow conduit having a centrally located longitudinally extending axis and an inner wall extending at least part way around said axis and defining a fluid flow path within the conduit which extends along said central axis;
providing a first elongated inclined baffle member positioned in said fluid flow path at a first location in said conduit;
providing a second elongated inclined baffle member positioned in said fluid flow path at a second location in said conduit, said second location being offset circumferentially from said first location and spaced longitudinally of the conduit from said first location,
the arrangement of said baffle members being such that neither is in contact with said wall and such that said mixer includes no additional baffle members which are aligned either circumferentially or longitudinally with either said first baffle member or said second baffle member; and
causing said flowable stream to flow along said fluid flow path.
